(19) United States
(12) Patent Application Publication
(10) Pub. No.: US 2026/0239498 A1
(43) Pub. Date: Aug. 13, 2026

(54) HEATING COOKER

(71) Applicant: SHARP KABUSHIKI KAISHA, Sakai City (JP)

(72) Inventors: Tomohiro KITAURA, Sakai City (JP); Mariko YACHI, Sakai City (JP); Shigenori MORIMOTO, Sakai City (JP)

(21) Appl. No.: 19/414,629

(22) Filed: Dec. 10, 2025

(30) Foreign Application Priority Data
Feb. 7, 2025 (JP) 2025-018887

(51) Int. Cl. H05B 6/64; G03B 17/55; H04N 7/18; H04N 23/55; H04N 23/57

(52) U.S. Cl. CPC H05B 6/6447; G03B 17/55; H04N 7/18; H04N 23/55; H04N 23/57; H05B 6/6402

(57) ABSTRACT

A heating cooker includes a heating compartment, an imaging device, and an optical member. The heating compartment has the panel member surrounding the compartment inner space capable of accommodating a heated object, and heats the heated object using an electromagnetic wave. The imaging device is arranged outside the heating compartment, and images the compartment inner space through the opening portion formed in a part of the panel member. The optical member is provided separately from the imaging device, and is disposed on the compartment inner space side as viewed from the imaging device.

### INCORPORATION BY REFERENCE

This application is based upon and claims the benefit of priority from the corresponding Japanese Patent Application No. 2025-018887 filed on February 7, 2025, the entire contents of which are incorporated herein by reference.

### BACKGROUND OF THE INVENTION

### 1. Technical Field

The present disclosure relates to a heating cooker.

### 2. Description of the Related Art

As a related art, a heating cooker (microwave heating device) such as a microwave oven that irradiates a heated object (object to be heated) in a heating compartment with an electromagnetic wave (microwave) to heat the heated object is known (see, for example, JP 2018-120779 A). The heating cooker according to the related art includes an imaging device (camera) that images (shoots) the inside of the heating compartment.

Since the heating cooker includes the imaging device capable of imaging the inside of the heating compartment, for example, the heated object can be identified by image recognition from the image captured by the imaging device, and the heating menu such as the intensity of the electromagnetic wave and the irradiation time can be set. Since the heated object can be imaged by the imaging device even during heating by electromagnetic wave irradiation, the intensity and irradiation time of the electromagnetic wave can be adjusted according to the heating state.

Here, the camera as an imaging device can shoot the inside of the heating compartment via an electromagnetic wave (microwave) shielding substrate provided in the opening. That is, since the electromagnetic wave shielding substrate is disposed on the front surface of the imaging device, the irradiation of the imaging device with the electromagnetic wave from the inside of the heating compartment is suppressed, and malfunction of the imaging device caused by the electromagnetic wave, generation and deterioration of noise, and the like can be suppressed.

### SUMMARY OF THE INVENTION

In the configuration of the above related technology, when the imaging device is moved away from the heating compartment serving as the heat source as a measure against heat of the imaging device, the outside of the heating compartment (the periphery of the opening) tends to appear in the image captured by the imaging device.

An object of the present disclosure is to provide a heating cooker in which an imaging device is less likely to deteriorate while reflection outside a heating compartment is suppressed.

A heating cooker according to one aspect of the present disclosure includes a heating compartment, an imaging device, and an optical member. The heating compartment has a panel member surrounding a compartment inner space capable of accommodating a heated object and heats the heated object using an electromagnetic wave. The imaging device is disposed outside the heating compartment and images an image of the compartment inner space through an opening portion formed in a part of the panel member. The optical member is separate from the imaging device and is disposed on the compartment inner space side as viewed from the imaging device.

According to the present disclosure, it is possible to provide the heating cooker in which the imaging device is less likely to deteriorate while suppressing reflection outside the heating compartment.

### BRIEF DESCRIPTION OF THE DRAWINGS

FIG. 1 is a schematic perspective view of a heating cooker according to a first embodiment;

FIG. 2 is a schematic perspective view of a main part of the heating cooker according to the first embodiment as viewed obliquely from below;

FIG. 3 is a schematic perspective view of a main part of the heating cooker according to the first embodiment as viewed obliquely from above;

FIG. 4 is a schematic perspective view of a main part of the heating cooker according to the first embodiment;

FIG. 5 is a schematic exploded perspective view of a main part of the heating cooker according to the first embodiment;

FIG. 6 is a schematic exploded perspective view of a main part of the heating cooker according to the first embodiment;

FIG. 7 is a schematic cross-sectional view of a main part of the heating cooker according to the first embodiment;

FIG. 8 is a cross-sectional view taken along line A1-A1 of FIG. 7, illustrating a main part of the heating cooker according to the first embodiment;

FIG. 9 is a schematic view illustrating a main part of the heating cooker according to the first embodiment and illustrating a relationship between a compartment inner holder and an optical member;

FIG. 10 is a schematic view illustrating a main part of a heating cooker according to Embodiment 1 and a specific configuration example of an optical member; and

FIG. 11 is a schematic view illustrating a main part of a heating cooker according to a second embodiment.

### DETAILED DESCRIPTION

Hereinafter, an embodiment of the present disclosure will be described with reference to the accompanying drawings. The embodiment below is an example embodying the present disclosure, and is not intended to limit the technical scope of the present disclosure.

### FIRST EMBODIMENT

### 1. General Outline

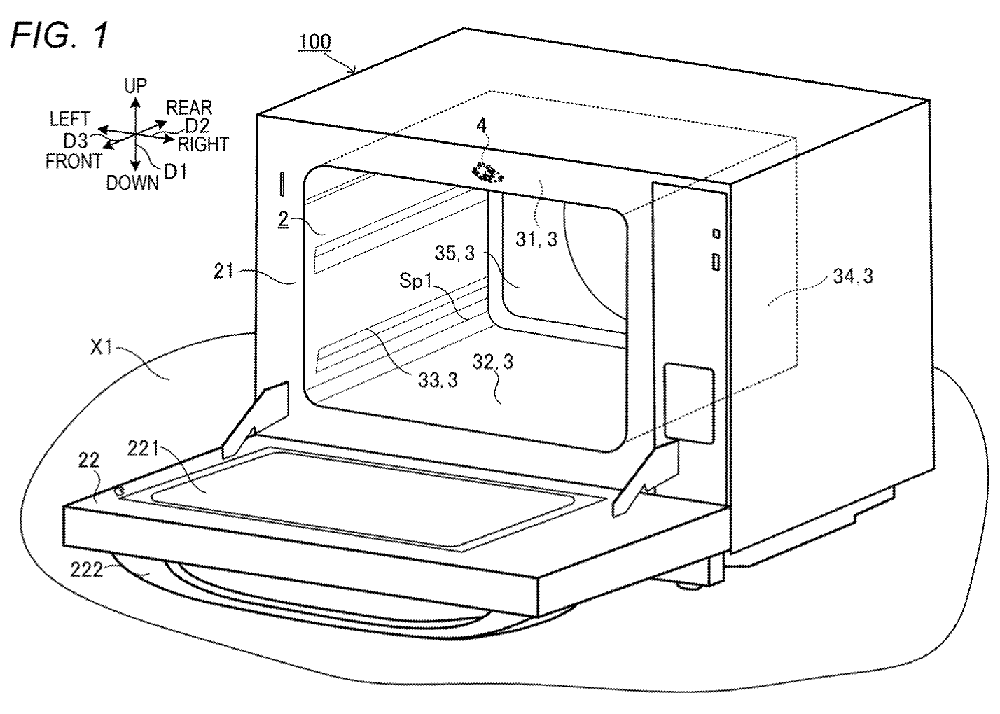

First, an outline of a heating cooker 100 according to the present embodiment will be described with reference to FIG. 1.

The heating cooker 100 according to the present embodiment heats, for example, a food, a food product, a beverage, or various other heated objects. The heating cooker 100 irradiates a heated object in a heating compartment 2 with an electromagnetic wave to heat the heated object, like a microwave oven, for example. The heating cooker 100 only needs to have a function of heating a heated object using at least an electromagnetic wave, and may have, for example, a grill function, an oven function of heating with convective heat, and/or a steam function of heating with water vapor.

The “electromagnetic wave” in the present disclosure means a physical phenomenon in which electromagnetic energy propagates in space while vibrating, and includes a radio wave and light. The heating cooker 100 irradiates a heated object in the heating compartment 2 with a microwave that is an electromagnetic wave of 2.45 GHz as an example. By this, an electromagnetic wave (microwave) vibrates a water molecule and the like in a heated object, and temperature of the entire heated object rises.

There are two types of the heating cooker 100 of this type, that is, “flat table type” and “turn table type”. A flat table type heating cooker includes an antenna below a bottom surface of a heating compartment. The antenna efficiently diffuses an electromagnetic wave radiated from a waveguide while rotating the antenna, and irradiates the inside of the heating compartment with the electromagnetic wave to evenly heat a heated object. A turntable type heating cooker includes a turntable in a heating compartment on which a heated object is placed, and irradiates the inside of the heating compartment with an electromagnetic wave from a waveguide while rotating the turntable, thereby uniformly heating the heated object on the turntable. In the present embodiment, as an example, the heating cooker 100 is a flat table type microwave oven.

The heating cooker 100 is, for example, an electric device that operates by receiving power supply from a power system (AC power supply). That is, the heating cooker 100 operates to heat a heated object by irradiating the heated object with an electromagnetic wave by receiving power supply.

As illustrated in FIG. 1, for example, the heating cooker 100 is used while being placed on an installation surface X1 including a shelf, a counter, or the like of a house. The heating cooker 100 stands independently on the installation surface X1 while being placed on the installation surface X1. That is, the heating cooker 100 according to the present embodiment is a self-standing and portable device, and the user can install the heating cooker 100 at an optional position on the installation surface X1.

In the present embodiment, for convenience of description, a vertical direction in a state where the heating cooker 100 can be used is defined as an up-down direction D1. Further, a left-right direction D2 is defined with reference to a direction in which the heating cooker 100 is viewed from the front, and a front-rear direction D3 is defined with the front surface side of the heating cooker 100 as the front side and the rear surface side as the rear side. However, these directions are not intended to limit a use direction (direction at the time of use) of the heating cooker 100.

The heating cooker 100 includes the heating compartment 2 capable of accommodating a heated object, and a heating source for heating the heated object. The heating source irradiates a space (compartment inner space Sp1) in the heating compartment 2 with an electromagnetic wave to heat a heated object accommodated in the heating compartment 2.

In the present embodiment, the heating compartment 2 has a hollow rectangular parallelepiped shape, and includes a box body 21 and a door body 22. The box body 21 is formed in a box shape with one surface (front surface in the present embodiment) opened. The door body 22 is attached to the box body 21 in a state where an opening surface (front surface in the present embodiment) of the box body 21 can be opened and closed.

Here, the door body 22 is supported to be openable and closable with respect to the box body 21 by a support portion (hinge) provided in a lower portion on the front surface side of the box body 21. An upper portion of the door body 22 falls to the front side to be at an open position (see FIG. 1), and stands to the back side to be at a closed position. Furthermore, the door body 22 includes a door window 221 through which the inside of the heating compartment 2 (compartment inner space Sp1) can be visually recognized through the door body 22, and a handle 222 that can be gripped by the user.

The door window 221 includes a double glass structure including an inner glass facing the inside (compartment inner space Sp1) of the door body 22 and an outer glass facing the outside of the door body 22. The door window 221 includes punching metal which is a metal plate (or a metal sheet) having a large number of holes. Provision of the punching metal prevents an electromagnetic wave from leaking out of the heating compartment 2 through the door window 221.

As illustrated in FIG. 1, when the door body 22 is in an open state (at an open position), the compartment inner space Sp1 in the heating compartment 2 is exposed from the front surface of the box body 21, so that a heated object can be put in and taken out of the heating compartment 2. On the other hand, when the door body 22 is in a closed state (at a closed position), the compartment inner space Sp1 in the heating compartment 2 is in a sealed state, so that a heated object accommodated in the heating compartment 2 can be heated.

Therefore, the user first puts a heated object into the heating compartment 2 with the door body 22 opened, and closes the door body 22. In this state, the heated object in the heating compartment 2 is irradiated with an electromagnetic wave from a heating source so that the heated object is heated. Then, after the heated object is heated, the user opens the door body 22 and takes out the heated object from the heating compartment 2.

Here, the heating compartment 2 includes a panel member 3 surrounding the compartment inner space Sp1. The panel member 3 is a member constituting an inner surface (inner side surface) of the heating compartment 2. An inner surface of the heating compartment 2 includes an upper surface (top surface), a lower surface (bottom surface), a left side surface, a right side surface, a back surface, and a front surface of the compartment inner space Sp1. That is, the panel member 3 is provided at each portion facing the compartment inner space Sp1 of the box body 21 and the door body 22.

In the present embodiment, as an example, as illustrated in FIG. 1, the box body 21 includes a first panel 31, a second panel 32, a third panel 33, a fourth panel 34, and a fifth panel 35 as the panel member 3. The first panel 31 constitutes an upper surface (top surface) of the compartment inner space Sp1, and the second panel 32 constitutes a lower surface (bottom surface) of the compartment inner space Sp1. The third panel 33 constitutes a left side surface of the compartment inner space Sp1, the fourth panel 34 constitutes a right side surface of the compartment inner space Sp1, and the fifth panel 35 constitutes a rear surface of the compartment inner space Sp1.

In other words, a space surrounded by the panel member 3 is an inner space of the heating compartment 2 (that is, the compartment inner space Sp1) capable of accommodating a heated object. The panel member 3 is made from metal so as to reflect an electromagnetic wave emitted into the heating compartment 2. That is, the panel member 3 is made from metal, reflects an electromagnetic wave with which the compartment inner space Sp1 is irradiated, and efficiently irradiates a heated object with an electromagnetic wave.

In the present embodiment, as an example, only the box body 21 is provided with the first panel 31 to the fifth panel 35 as the panel member 3, and each of the first panel 31 to the fifth panel 35 is constituted by a metal plate having a predetermined thickness. However, the panel member 3 may be divided into a plurality of members, and for example, the second panel 32, the third panel 33, the fourth panel 34, and the like may be integrally constituted.

Here, at least the first panel 31 to the fifth panel 35 as the panel member 3 are electrically connected to a grounding point electrically connected to, for example, a ground terminal of an outlet with a ground terminal. That is, as the first panel 31 to the fifth panel 35 are grounded, a shielding effect against an electromagnetic wave (here, microwave) is enhanced. Therefore, an electromagnetic wave is shielded by the panel member 3, and hardly leaks to the outside of the heating compartment 2 (to the outside of the compartment inner space Sp1).

Further, the heating cooker 100 according to the present embodiment further includes a power supply unit, an operation unit, a controller, and the like. Furthermore, the heating cooker 100 further includes various sensors such as a weight sensor and a temperature sensor.

The operation unit is arranged on a front surface of the door body 22, for example. The operation unit includes a plurality of buttons, dials, and the like that can be pressed and operated by the user. The operation unit receives, for example, start and stop of heating of a heated object, setting operation of heating intensity, heating time, and heating mode, and the like.

The controller is electrically connected to a heating source, a power supply unit, an operation unit, and the like. The controller mainly includes a computer system including one or more processors such as a central processing unit (CPU) and one or more memories such as a read only memory (ROM) and a random access memory (RAM), and executes various types of processing (information processing). The controller controls each unit of the heating cooker 100 according to operation of the operation unit.

The heating cooker 100 according to the present embodiment further includes an imaging device 4 that images the compartment inner space Sp1. The imaging device 4 is a camera including an imaging element (photoelectric conversion element) such as a charge coupled device (CCD) sensor or a complementary metal-oxide-semiconductor (CMOS) sensor. The imaging device 4 including a camera includes an optical system such as a lens in addition to an imaging element, and outputs an image of the compartment inner space Sp1 as needed.

In the present embodiment, the imaging device 4 is connected to the controller, and an image captured by the imaging device 4 is input to the controller regularly or irregularly. The controller performs appropriate image processing on an image of the inside of the heating compartment 2 (compartment inner space Sp1) to monitor a state of the inside of the heating compartment 2 to be used for favorable control of each part of the heating cooker 100.

As an example, the controller estimates what a heated object accommodated in the heating compartment 2 is, or in what state (presence or absence of a lid) the heated object is accommodated based on an image acquired from the imaging device 4, and automatically sets heating intensity, heating time, a heating mode, and the like. Further, the controller may use an image acquired from the imaging device 4 to detect whether a heated object is put into or taken out of the heating compartment 2, detect dirt in the heating compartment 2 (or on the door window 221), and monitor other parts (including the outside of the heating compartment 2).

Here, the imaging device 4 is fixed to the panel member 3 surrounding the compartment inner space Sp1 such that the compartment inner space Sp1 is included in a field of view. In the present embodiment, in particular, the imaging device 4 is fixed obliquely downward to the first panel 31 constituting an upper surface (top surface) of the compartment inner space Sp1 of the panel member 3. By this, the imaging device 4 can image the compartment inner space Sp1 as looking down from obliquely above.

### 2.Detailed Configuration Around Imaging Device

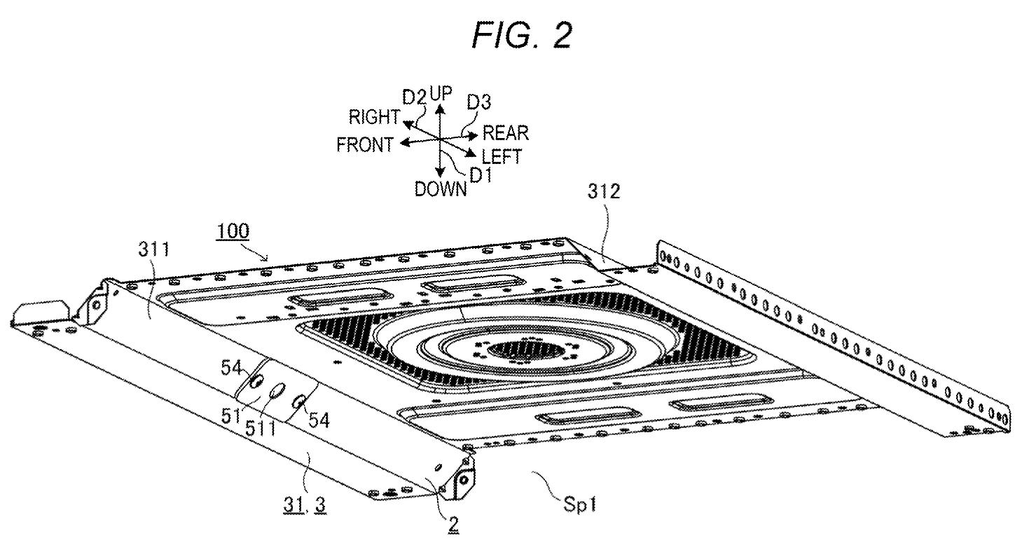

Next, a more detailed configuration around the imaging device 4 (camera) in the heating cooker 100 according to the present embodiment will be described with reference to FIGS. 2 to 10.

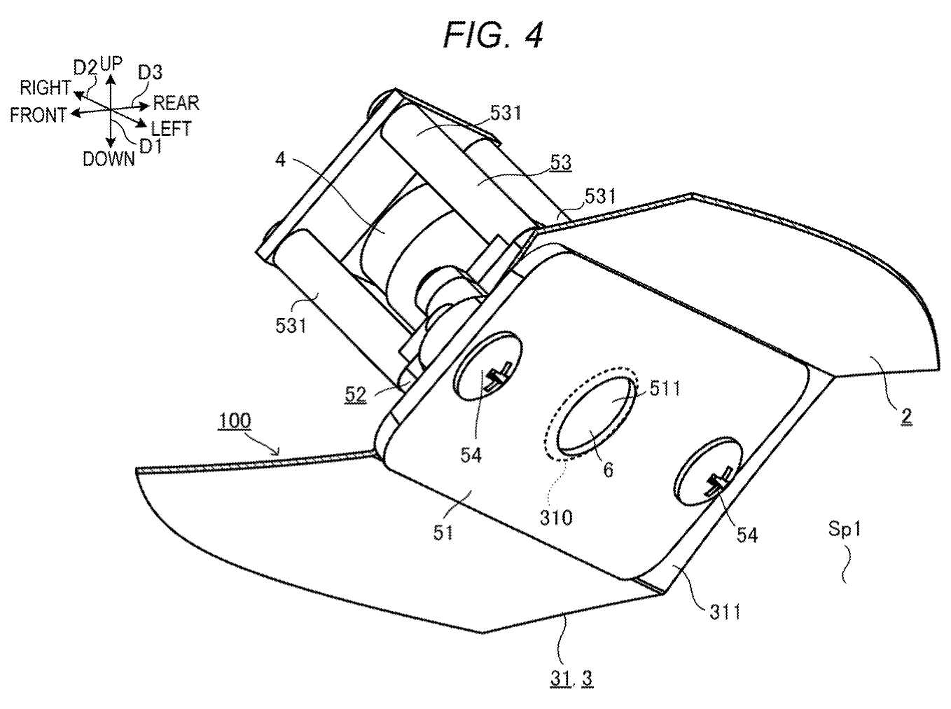

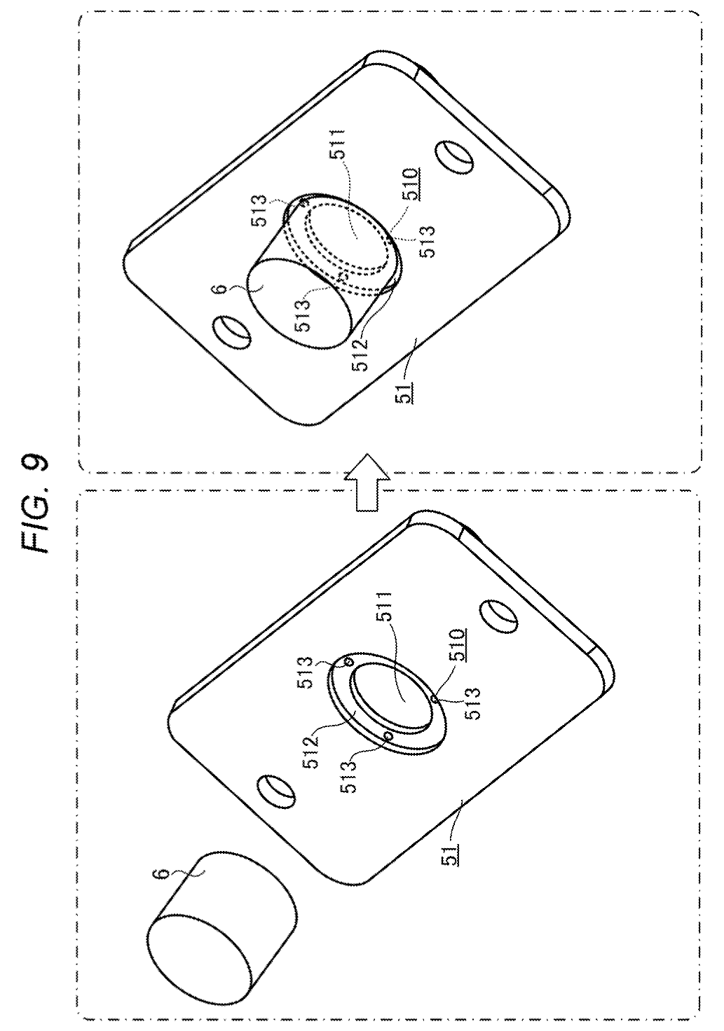

In FIGS. 2 to 10, only the first panel 31 to which the imaging device 4 is fixed, the imaging device 4, and peripheral members of the imaging device 4 such as a compartment inner holder 51 and a compartment outer holder 52 are illustrated, and illustration of other members is appropriately omitted. Furthermore, in FIGS. 4 to 10, only the peripheral portion of the imaging device 4 is cut out and illustrated for the first panel 31. In FIG. 9, illustration of the imaging device 4 is also omitted.

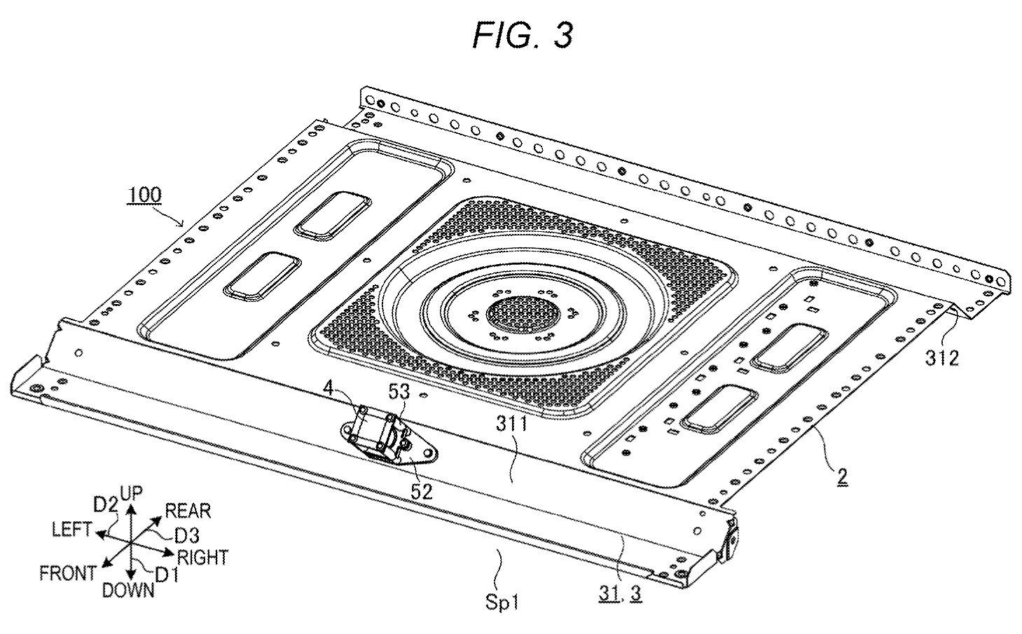

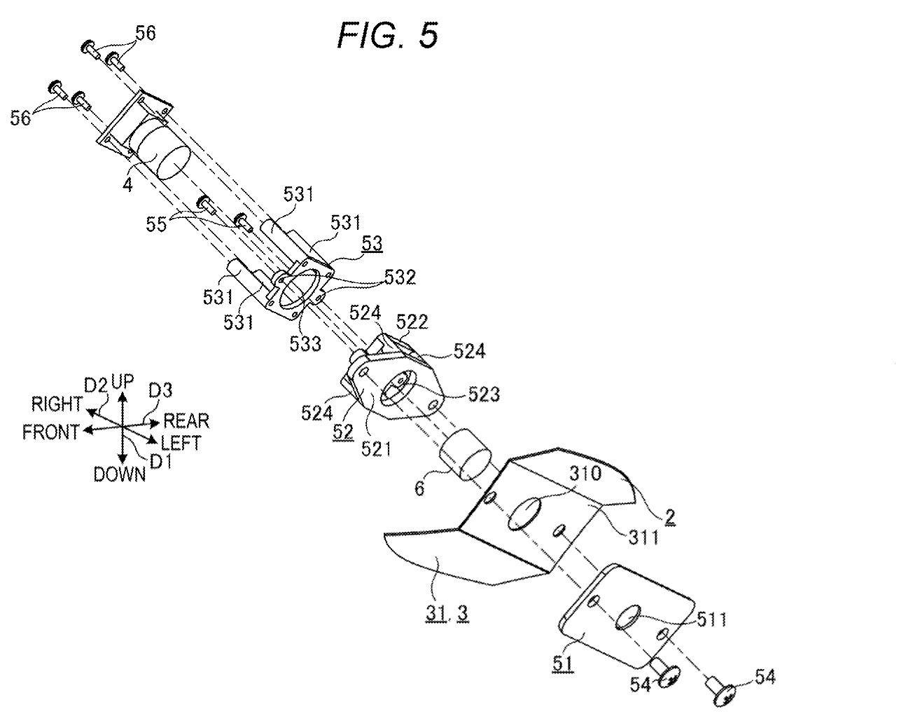

As illustrated in FIGS. 2 and 3, the heating cooker 100 according to the present embodiment includes the compartment inner holder 51, the compartment outer holder 52, a camera holder 53, screws 54, an optical member 6, and the like. The heating cooker 100 further includes fixing screws 55 and 56 (see FIG. 5).

The imaging device 4 is fixed to a central portion in the left-right direction D2 of a front end of the first panel 31. Specifically, the first panel 31 is formed by bending a metal plate, and has inclined portions 311 and 312 inclined so as to be lower toward both end sides in the front-rear direction D3 at both ends in the front-rear direction D3.

The imaging device 4 is supported by the inclined portion 311 on the front side of the first panel 31. More specifically, an opening portion 310 (see FIG. 5) is formed at a central portion in the left-right direction D2 of the inclined portion 311 of the first panel 31. The opening portion 310 is a through hole penetrating (the inclined portion 311 of) the first panel 31 in a thickness direction. Here, as an example, the opening portion 310 is opened in a circular shape. The imaging device 4 is arranged above the first panel 31, that is, outside the heating compartment 2, at a position corresponding to the opening portion 310.

Further, the imaging device 4 is arranged in a posture in which an optical axis of an optical system is inclined downward (obliquely downward) from a horizontal direction such that the optical axis of the optical system passes through substantially the center of the opening portion 310. In the present embodiment, as an example, the inclined portion 311 is inclined rearward by 45 degrees. For this reason, the imaging device 4 is also arranged in a posture in which the optical axis of the optical system is inclined rearward by 45 degrees with respect to the vertical direction.

By this, the imaging device 4 arranged outside the heating compartment 2 (above the first panel 31) can image the inside of the heating compartment 2 (compartment inner space Sp1) through the opening portion 310. That is, the imaging device 4 can image the compartment inner space Sp1 in a bird's-eye view manner from obliquely forward and upward.

In the present embodiment, as illustrated in FIGS. 3 to 6, the imaging device 4 is supported above the first panel 31, that is, outside the heating compartment 2 by the camera holder 53. The camera holder 53 has, around an optical axis of the optical system of the imaging device 4, a plurality of (here, four) leg portions 531 extending along the optical axis. Here, as an example, the camera holder 53 is made from resin (resin molded article).

The camera holder 53 is attached to the panel member 3 from the outside (upper side) of the heating compartment 2 in a posture in which one end (lower end) of a plurality of the leg portions 531 faces the panel member 3 (first panel 31) side, and the imaging device 4 is attached to another end (upper end) of the plurality of leg portions 531. Specifically, the camera holder 53 is fixed to the compartment outer holder 52 by fasteners such as fixing screws 55. With respect to a peripheral portion of the opening portion 310 of the first panel 31, the compartment outer holder 52 and the compartment inner holder 51 are fixed by a pair of screws 54 such that the first panel 31 is sandwiched between the compartment outer holder 52 and the compartment inner holder 51. Consequently, the camera holder 53 is indirectly fixed to the panel member 3 (first panel 31) through the compartment outer holder 52. The imaging device 4 is fixed to the plurality of leg portions 531 by fasteners such as the fixing screws 56.

For this reason, the imaging device 4 is supported by the camera holder 53 in a state of being separated from the panel member 3 (first panel 31) to the outside (upper side) of the heating compartment 2. Furthermore, since a cavity is also secured between the plurality of leg portions 531 in the camera holder 53, cooling air can pass around the imaging device 4, and a cooling effect of the imaging device 4 can be easily obtained.

The camera holder 53 has an opening portion 533 for exposing a distal end (lower end) of the imaging device 4. The opening portion 533 is formed in a circular shape centered on the optical axis of the optical system of the imaging device 4. The diameter of the opening portion 533 is set to be slightly larger than the outer diameter of the distal end of the imaging device 4.

More specifically, a pair of through holes 532 (see FIG. 5) separated in the left-right direction D2 is formed at an end (lower end) of the camera holder 53 on the panel member 3 (first panel 31) side. On the other hand, the compartment outer holder 52 has a pair of screw holes 527 (see FIG. 5) formed at positions corresponding to the pair of through holes 532. The camera holder 53 is fixed to the compartment outer holder 52 by fastening the fixing screws 55 to the screw holes 527 from the camera holder 53 side (upper side) through the through holes 532, respectively.

The optical member 6 is provided separately from the imaging device 4, and is disposed on the compartment inner space Sp1 side as viewed from the imaging device 4. That is, the optical member 6 and the imaging device 4 are separate components that can be handled separately. The optical member 6 is disposed between the imaging device 4 and the compartment inner space Sp1.

The optical member 6 is a member of an optical system including a lens and/or a mirror, and optically couples the compartment inner space Sp1 and the imaging device 4. Since the optical member 6 is located on the optical axis of the optical system of the imaging device 4 disposed toward the compartment inner space Sp1, the imaging device 4 can image the inside of the heating compartment 2 (compartment inner space Sp1) via the optical member 6.

In the present embodiment, as an example, the optical member 6 is formed in a columnar shape having a height along the optical axis of the optical system of the imaging device 4. Here, the diameter of the optical member 6 is set to be equal to or smaller than the diameter of the opening portion 310 of the first panel 31 so that the optical member 6 can pass through the opening portion 310 of the first panel 31.

In the present embodiment, the optical member 6 includes a conversion lens. That is, by positioning the optical member 6 on the optical axis of the optical system of the imaging device 4, the angle of view that can be imaged by the imaging device 4 can be changed with respect to the angle of view of the imaging device 4 alone. The optical member 6 has transparency to at least light in a wavelength range in which the imaging device 4 has sensitivity. The configuration of the optical member 6 will be described later in detail.

The optical member 6 is attached to the panel member 3 (first panel 31) so as to be sandwiched between the compartment inner holder 51 and the compartment outer holder 52 in the optical axis direction of the optical system of the imaging device 4. Specifically, both the compartment inner holder 51 and the compartment outer holder 52 are frame-shaped members having the through holes 511 and 526 and are coupled to each other by being fixed to a peripheral portion of the opening portion 310 in the first panel 31 in a state where the optical member 6 is sandwiched and held therebetween.

The compartment inner holder 51 is located on the inside (lower side) of the heating compartment 2 with respect to the first panel 31, and the compartment outer holder 52 is located on the outside (upper side) of the heating compartment 2 with respect to the first panel 31. Here, as an example, the compartment inner holder 51 is formed in a rectangular frame shape having a length in the left-right direction D2, and the compartment outer holder 52 is formed in a substantially rhombic frame shape having a length in the left-right direction D2. As an example, the compartment inner holder 51 is made of metal, and the compartment outer holder 52 is made of resin (resin molded article).

With the optical member 6 sandwiched between the compartment inner holder 51 and the compartment outer holder 52, the compartment inner holder 51 and the compartment outer holder 52 are fixed to a peripheral portion of the opening portion 310 of the first panel 31 by the pair of screws 54. In the present embodiment, the pair of screws 54 is inserted from the inside of the heating compartment 2, that is, from the compartment inner holder 51, and fastened to the compartment outer holder 52 through the first panel 31. Accordingly, the compartment inner holder 51 and the compartment outer holder 52 are fixed to the first panel 31 so as to sandwich the first panel 31. As a result, the optical member 6 sandwiched and held between the compartment inner holder 51 and the compartment outer holder 52 is attached to the panel member 3 (first panel 31) so as to penetrate the opening portion 310.

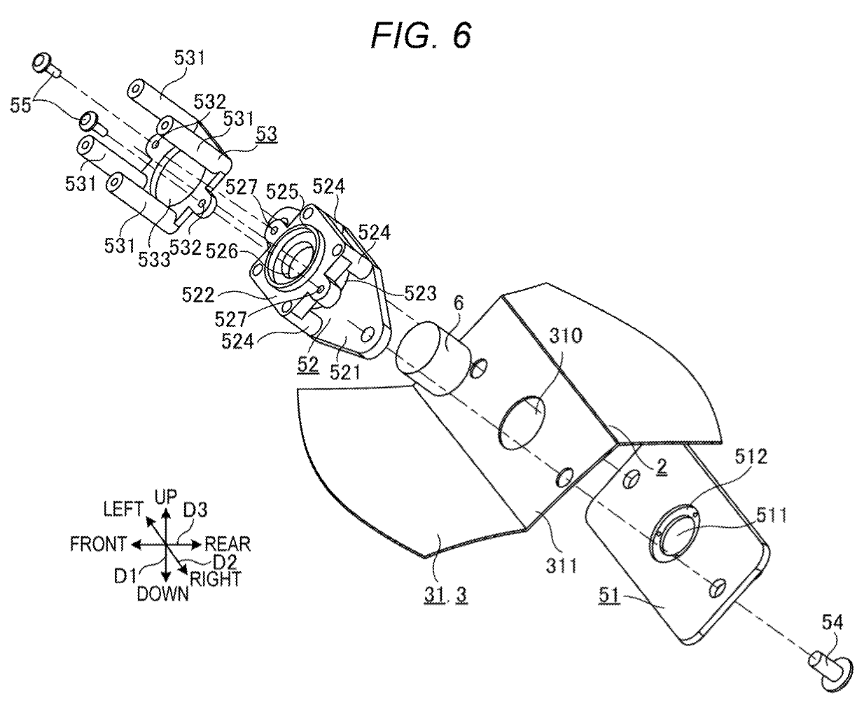

As illustrated in FIGS. 5 and 6, the compartment inner holder 51 has the through hole 511 that opens in a circular shape, and the compartment outer holder 52 has the through hole 526 that opens in a circular shape. The optical member 6 sandwiched between the compartment inner holder 51 and the compartment outer holder 52 is thus exposed to the inside (lower side) of the heating compartment 2 through the through hole 511, and is exposed to the outside (upper side) of the heating compartment 2 through the through hole 526. Therefore, the imaging device 4 can image the compartment inner space Sp1 through the optical member 6 through the through hole 526, the opening portion 310, and the through hole 511.

More specifically, as illustrated in FIGS. 5 and 6, the compartment inner holder 51 has the through hole 511 penetrating the compartment inner holder 51 in the thickness direction at the center of the surface (lower surface) facing the inside (lower side) of the heating compartment 2. The through hole 511 opens in a circular shape having a diameter smaller than the diameter of the optical member 6. Further, the compartment inner holder 51 has, around the through hole 511 on the rear surface (upper surface) facing the outside (upper side) of the heating compartment 2, a counterbore portion 512 recessed concentrically with the through hole 511. The diameter of the counterbore portion 512 is slightly larger than the diameter of the through hole 511. That is, when viewed from the outside (upper side) of the heating compartment 2, the through hole 511 is disposed inside the counterbore portion 512.

As illustrated in FIGS. 5 and 6, the compartment outer holder 52 includes a first plate 521, a second plate 522, and a plurality of (here, four) column portions 524. The first plate 521 and the second plate 522 are arranged to face each other in the optical axis direction of the optical system of the imaging device 4 such that the first plate 521 is on the first panel 31 side (lower side). The pair of screw holes 527 is disposed in the second plate 522 of the compartment outer holder 52.

The first plate 521 is formed in a substantially rhombus shape having a length in the left-right direction D2. The first plate 521 is disposed to face the first panel 31, and is fixed to a peripheral portion of the opening portion 310 of the first panel 31 by the pair of screws 54 so as to sandwich the first panel 31 with the compartment outer holder 52. The first plate 521 is formed with the through hole 523 penetrating the first plate 521 in the thickness direction at the center of the bottom surface of the recess 521 at the center of the surface (lower surface) facing the inside (lower side) of the heating compartment 2. The through hole 523 opens in a circular shape having a diameter larger than the diameter of the optical member 6.

The second plate 522 is formed in a square shape. The second plate 522 has the through hole 526 penetrating the second plate 522 in the thickness direction at the center of the surface (lower surface) facing the first plate 521. The through hole 526 opens in a circular shape having a diameter smaller than the diameter of the optical member 6. Further, the second plate 522 has a counterbore portion 528 recessed concentrically with the through hole 526 around the through hole 526 on the surface (lower surface) facing the first plate 521. The diameter of the counterbore portion 528 is slightly larger than the diameter of the through hole 526. That is, when viewed from the first plate 521 side (lower side), the through hole 526 is disposed inside the counterbore portion 528.

Each of the plurality of column portions 524 has a length along the optical axis, and is a member connecting the first plate 521 and the second plate 522. The plurality of column portions 524 are arranged at four corners of the second plate 522 so as to surround the counterbore portion 528.

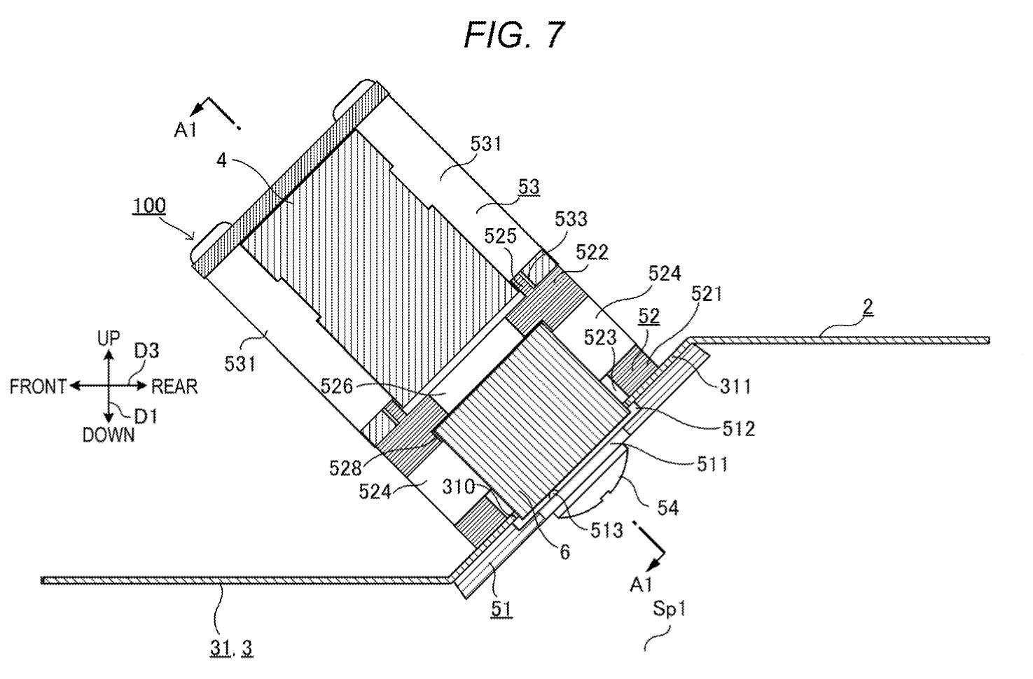

Further, the second plate 522 has a peripheral wall 525 protruding to the outside (upper side) of the heating compartment 2 around the through hole 526 on the rear surface (upper surface) facing the outside (upper side) of the heating compartment 2. The outer diameter of the peripheral wall 525 is slightly smaller than the inner diameter of the opening portion 533 of the camera holder 53, and the inner diameter of the peripheral wall 525 is slightly larger than the outer diameter of the distal end (lower end) of the imaging device 4. By providing such a peripheral wall 525, the distal end of the imaging device 4 can be inserted into the space surrounded by the peripheral wall 525 in a state where the camera holder 53 holding the imaging device 4 is attached to the compartment outer holder 52 (see FIG. 7).

With the configuration described above, the optical member 6 is sandwiched and held between the counterbore portion 512 of the compartment inner holder 51 and the counterbore portion 528 of the compartment outer holder 52 in a state where the compartment inner holder 51 and the compartment outer holder 52 are coupled to each other. That is, the surface (lower surface) of the optical member 6 facing the inside (lower side) of the heating compartment 2 is supported by the bottom surface of the counterbore portion 512, and the surface (upper surface) of the optical member 6 facing the outside (upper side) of the heating compartment 2 is supported by the bottom surface of the counterbore portion 528. In this state, the optical member 6 penetrates the through hole 523 of the first plate 521 and the opening portion 310 of the first panel 31, so that an end (lower end) of the optical member 6 on the inner side (lower side) of the heating compartment 2 slightly protrudes from the first panel 31 toward the inner side of the heating compartment 2. Further, both ends of the optical member 6 in the optical axis direction are fitted into the counterbore portions 512 and 528, so that the optical member 6 is positioned in a plane orthogonal to the optical axis.

In addition, the second plate 522 is interposed between the imaging device 4 and the optical member 6 in the optical axis direction of the optical system of the imaging device 4. As a result, the optical member 6 is separated from the surface (lower surface) of the imaging device 4 facing the panel member 3 (first panel 31), and is disposed so as to have a gap with the imaging device 4 in the optical axis direction of the optical system of the imaging device 4 (see FIG. 7).

Here, focusing on the magnitude relationship of the diameters of the members around the optical member 6, the diameters of the counterbore portion 512 and the through hole 523 are the largest, and the diameter decreases in the order of the opening portion 310, the counterbore portion 528, the optical member 6, and the through holes 511 and 526.

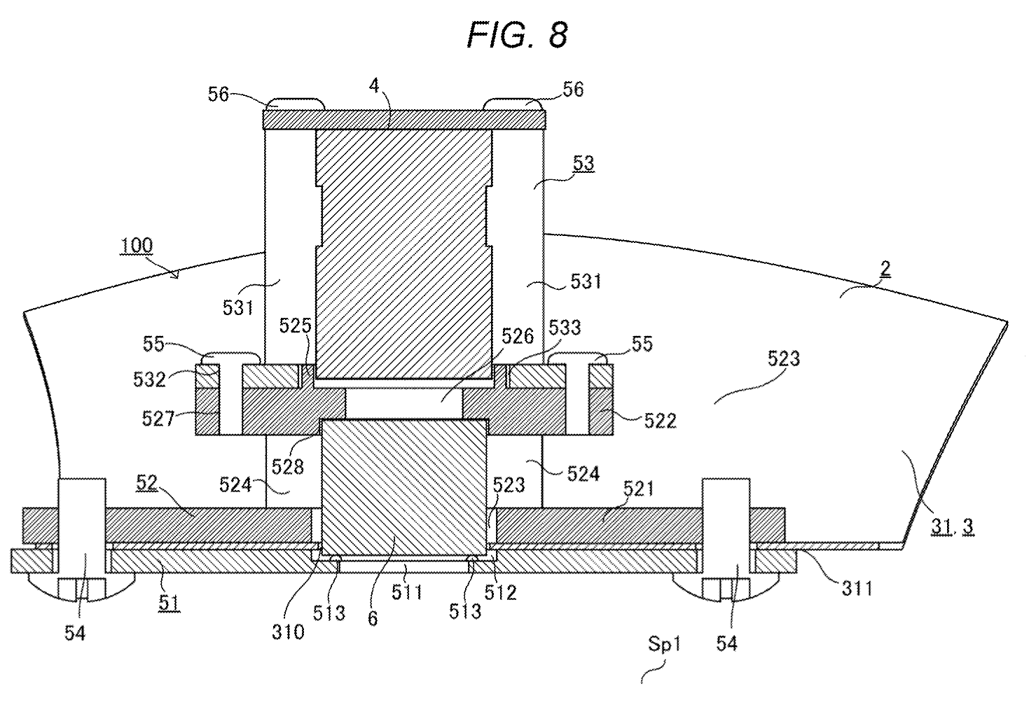

In short, as illustrated in FIGS. 7 and 8, the heating cooker 100 according to the present embodiment includes the heating compartment 2, the imaging device 4, and the optical member 6. The heating compartment 2 has the panel member 3 surrounding the compartment inner space Sp1 capable of accommodating a heated object, and heats the heated object using an electromagnetic wave. The imaging device 4 is arranged outside the heating compartment 2, and images the compartment inner space Sp1 through the opening portion 310 formed in a part of the panel member 3. The optical member 6 is provided separately from the imaging device 4, and is disposed on the compartment inner space Sp1 side as viewed from the imaging device 4.

That is, when viewed from the compartment inner space Sp1 side, the optical member 6 is disposed in front of the imaging device 4. Therefore, the imaging device 4 is set back to the outside of the heating compartment 2 with respect to the opening portion 310 by at least the optical member 6, and is disposed away from the heating compartment 2 serving as a heat source, so that a countermeasure against heat of the imaging device 4 can be taken. Therefore, even if heat in the compartment inner space Sp1 leaks to the outside of the heating compartment 2 through the opening portion 310, the heat is less likely to reach the imaging device 4.

Moreover, since the optical member 6 is disposed on the side of the compartment inner space Sp1 as viewed from the imaging device 4, the imaging device 4 can image the compartment inner space Sp1 via the optical member 6. In other words, since the compartment inner space Sp1 and the imaging device 4 can be optically coupled by the optical member 6, reflection outside the heating compartment 2 (around the opening portion 310) can be suppressed while the imaging device 4 is set back to the outside of the heating compartment 2 with respect to the opening portion 310. Therefore, the heating cooker 100 according to the present embodiment has an advantage that the imaging device 4 is less likely to deteriorate while reflection outside the heating compartment 2 is suppressed.

In the present embodiment, the optical member 6 includes a conversion lens. Therefore, by adjusting the angle of view of the imaging device 4 with the conversion lens, it is possible to efficiently image the inside of the heating compartment 2 (compartment inner space Sp1) while suppressing reflection outside the heating compartment 2 (around the opening portion 310).

The heating cooker 100 further includes at least one of a first coupling structure and a second coupling structure. The first coupling structure is a structure configured to mechanically couple the optical member 6 and the panel member 3 (first panel 31). The second coupling structure is a structure configured to mechanically couple the optical member 6 and the imaging device 4. That is, the heating cooker 100 fixes the optical member 6 disposed between the imaging device 4 and the compartment inner space Sp1 by the first coupling structure and/or the second coupling structure. In the present embodiment, the heating cooker 100 has both the first coupling structure and the second coupling structure.

That is, in the present embodiment, as described above, the optical member 6 is mechanically coupled to the panel member 3 (first panel 31) via the compartment inner holder 51 and the compartment outer holder 52 so as to be sandwiched between the compartment inner holder 51 and the compartment outer holder 52. Therefore, the compartment inner holder 51 and the compartment outer holder 52 constitute the first coupling structure. The camera holder 53 that holds the imaging device 4 is fixed to the compartment outer holder 52 that holds the optical member 6, so that the optical member 6 is mechanically coupled to the imaging device 4 via the compartment outer holder 52 and the camera holder 53. Therefore, the compartment outer holder 52 and the camera holder 53 constitute the first coupling structure.

As described above, the heating cooker 100 includes the first coupling structure and/or the second coupling structure, so that the optical member 6 can be disposed between the imaging device 4 and the compartment inner space Sp1.

The heating cooker 100 further includes a first positioning portion and a second positioning portion. The first positioning portion defines the position of the optical member 6 in a plane orthogonal to the optical axis of the imaging device 4. The second positioning portion defines the position of the optical member 6 in the optical axis direction of the imaging device 4.

In the present embodiment, as described above, both ends of the optical member 6 in the optical axis direction are fitted into the counterbore portions 512 and 528, so that the optical member 6 is positioned in a plane orthogonal to the optical axis. That is, (the inner peripheral surfaces of) the counterbore portions 512 and 528 constitute the first positioning portion. On the other hand, since optical member 6 is held so as to be sandwiched between the compartment inner holder 51 and the compartment outer holder 52, the optical member 6 is positioned in the optical axis direction by the compartment inner holder 51 and the compartment outer holder 52. That is, (the bottom surfaces of the counterbore portions 512 and 528 of the compartment inner holder 51 and the compartment outer holder 52) constitute the second positioning portion.

According to this configuration, since the optical member 6 is positioned with respect to the imaging device 4, the imaging range can be accurately set by the imaging device 4 in the compartment inner space Sp1.

The heating cooker 100 further includes a shielding portion. The shielding portion surrounds a gap between the optical member 6 and the imaging device 4 to shield incident light to the gap. In the present embodiment, as illustrated in FIGS. 7 and 8, the optical member 6 is combined with the second plate 522 from the heating compartment 2 side (lower side) so as to be fitted in the counterbore portion 528, and the imaging device 4 is combined with the second plate 522 from the opposite side (upper side) to the heating compartment 2 so as to be fitted in the peripheral wall 525. The optical member 6 and the imaging device 4 face each other through the through hole 526 of the second plate 522.

That is, in the present embodiment, (the peripheral wall 525 and the inner peripheral surface of the through hole 526 of) the second plate 522 constitutes a shielding portion that surrounds the gap between the optical member 6 and the imaging device 4. This can suppress reflection of external light from the heating compartment 2 due to incidence of external light from a gap between the optical member 6 and the imaging device 4.

As illustrated in FIG. 9, the heating cooker 100 according to the present embodiment further includes a support portion 510. The support portion 510 supports the optical member 6 by coming into contact with one end face of the optical member 6 in the optical axis direction of the imaging device 4 at three or more support points 513.

Specifically, as illustrated on the left side of FIG. 9, the support portion 510 includes three support points 513. Each of these three support points 513 protrudes from the bottom surface of the counterbore portion 512 of the compartment inner holder 51. The three support points 513 are arranged at intervals in the circumferential direction of the through hole 511, and are arranged at equal intervals (120 ° intervals) as an example in the present embodiment.

As illustrated on the right side of FIG. 9, in a state where the compartment inner holder 51 and the optical member 6 are combined, the support portion 510 supports the optical member 6 by bringing all three support points 513 into contact with one end face (lower end face) of the optical member 6. Accordingly, even when the flatness of the bottom surface of the counterbore portion 512 is low, the optical member 6 can be easily supported by the support portion 510 of the compartment inner holder 51 without being inclined.

The heating cooker 100 further includes a cooling structure configured to cool the optical member 6. In the present embodiment, a cavity is secured between the plurality of column portions 524 between the first plate 521 and the second plate 522 in the compartment outer holder 52, so that cooling air can pass around the optical member 6, and an effect of cooling the optical member 6 can be easily obtained. As a result, an increase in the temperature of the optical member 6 can be suppressed, and heat is less likely to be transferred to the imaging device 4.

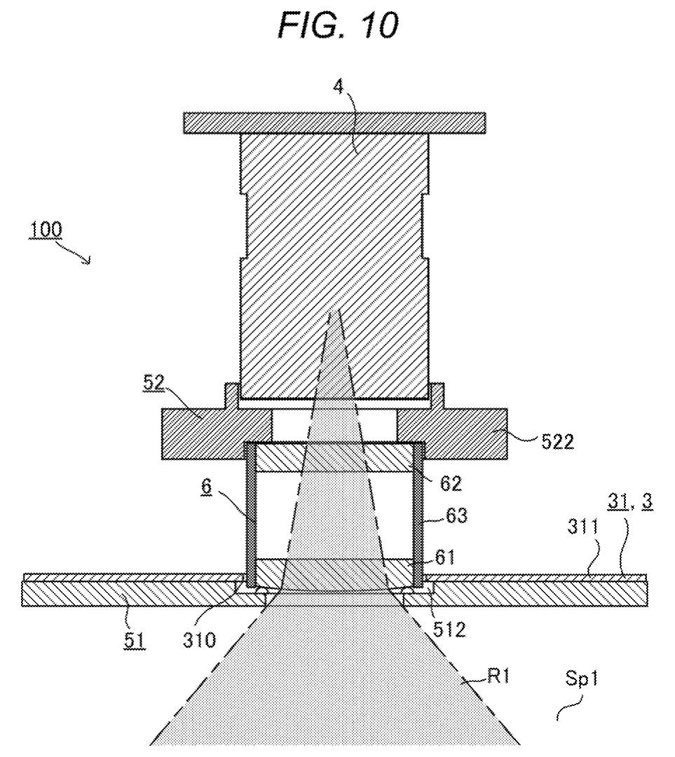

Meanwhile, FIG. 10 illustrates a configuration example of the optical member 6 including a conversion lens. As illustrated in FIG. 10, the optical member 6 includes a first lens 61, a second lens 62, and a cylindrical portion 63. The first lens 61 and the second lens 62 are disposed so as to face each other in the optical axis direction of the optical system of the imaging device 4 such that the first lens 61 is on the heating compartment 2 side (lower side). The cylindrical portion 63 is formed in a hollow cylindrical shape, and the first lens 61 and the second lens 62 are arranged at both ends thereof.

The first lens 61 is a wide-angle plano-convex lens, and realizes a wide viewing angle R1 (angle of view) in the imaging device 4. The second lens 62 is a lens having a function of optimizing a viewing angle and a viewing range from an image captured at the wide viewing angle R1.

According to this configuration, a space surrounded by the first lens 61, the second lens 62, and the cylindrical portion 63 functions as a heat insulating layer. The heat insulating layer is an air layer, but is not limited to the air layer, and may be a layer having a lower thermal conductivity than at least the first lens 61, such as a vacuum layer, a gas layer other than air, or a liquid layer. That is, the optical system of the imaging device 4 is thermally separated from the first lens 61 by the heat insulating layer, and the heat transmitted through the first lens 61 hardly reaches the imaging device 4.

### 3. Modified Examples

Hereinafter, modified examples of the first embodiment will be listed. The modified examples described below can be appropriately combined and applied.

The optical member 6 is not limited to a conversion lens. The optical member 6 is a member of an optical system including a lens and/or a mirror, and may optically couple the compartment inner space Sp1 and the imaging device 4. For example, the optical member 6 may be configured by a combination of a lens and a mirror.

Further, the opening portion 310 only needs to be arranged at any position of the panel member 3, and may be provided, for example, in a rear end of the first panel 31, or may be provided in the second panel 32, the third panel 33, the fourth panel 34, or the fifth panel 35. Furthermore, in a case where the imaging device 4 is arranged on the door body 22, the opening portion 310 may be provided in a panel member constituting an inner surface of the door body 22.

Further, the various components such as the compartment outer holder 52 and the camera holder 53 are not limited to being made of resin, and for example, at least a part thereof may be made of metal or the like. Furthermore, the compartment inner holder 51 is not limited to being made of metal, and for example, at least a part thereof may be made of resin (resin molded article).

The heating cooker 100 only needs to have at least one of the first coupling structure and the second coupling structure, and does not necessarily have both the first coupling structure and the second coupling structure. That is, the heating cooker 100 may include only one of a first coupling structure configured to mechanically couple the optical member 6 and the panel member 3 (first panel 31) and a second coupling structure configured to mechanically couple the optical member 6 and the imaging device 4.

### Second Embodiment

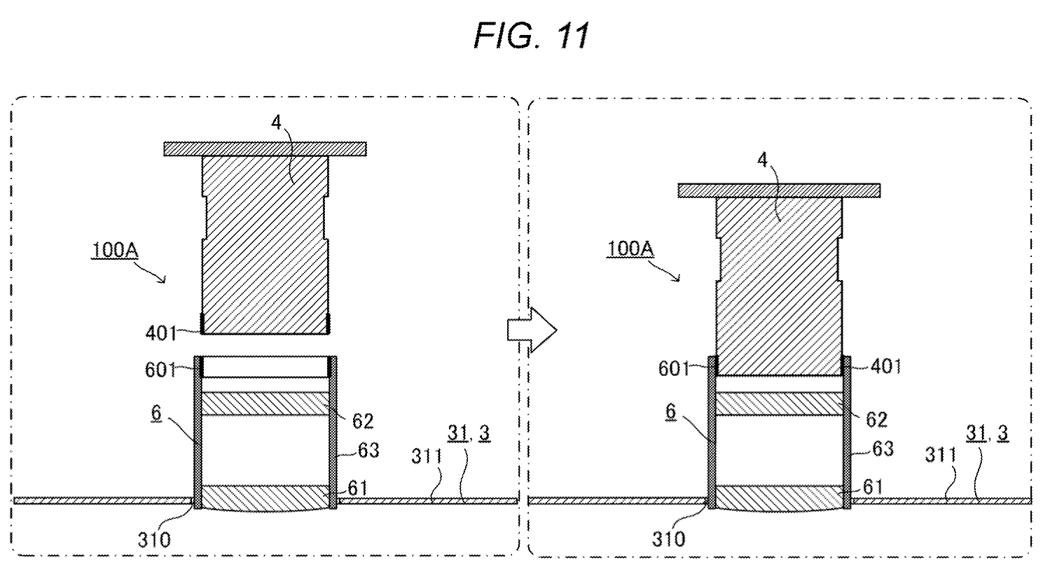

As illustrated in FIG. 11, the heating cooker 100A according to the present embodiment is different from that of the first embodiment in a structure for fixing the optical member 6. Hereinafter, a configuration similar to that of the first embodiment is denoted by a common reference numeral, and appropriately omitted from description.

As illustrated in FIG. 11, the heating cooker 100A adopts a structure in which the optical member 6 is fixed by directly coupling the optical member 6 to the imaging device 4. Although not illustrated in FIG. 11, also in the present embodiment, the imaging device 4 is held by the camera holder 53, and the camera holder 53 is fixed to the panel member 3 (first panel 31) so as to be fixed to the panel member 3 via the camera holder 53.

Specifically, as illustrated on the left side of FIG. 11, the optical member 6 has a first coupling portion 601 at an extended portion obtained by extending an end (upper end) of the cylindrical portion 63 on the imaging device 4 side. The imaging device 4 has a second coupling portion 401 at an end (lower end) on the optical member 6 side. The first coupling portion 601 and the second coupling portion 401 have a structure capable of being coupled to each other.

In the present embodiment, as an example, the first coupling portion 601 is a screw groove (female screw) formed on the inner peripheral surface of the cylindrical portion 63, and the second coupling portion 401 is, for example, a screw groove (male screw) formed on the outer peripheral surface of the imaging device 4. Thus, by screwing the second coupling portion 401 of the imaging device 4 into the first coupling portion 601 of the optical member 6, as illustrated on the right side of FIG. 11, the optical member 6 and the imaging device 4 can be mechanically coupled by the first coupling portion 601 and the second coupling portion 401.

In the present embodiment, the end (lower end) of the optical member 6 on the compartment inner space Sp1 side is inserted into the opening portion 310 of the panel member 3 (first panel 31), so that the optical member 6 is positioned in a plane orthogonal to the optical axis. That is, (the inner peripheral surface of) the opening portion 310 constitutes the first positioning portion. On the other hand, since the optical member 6 is directly coupled to the imaging device 4, the optical member 6 is positioned in the optical axis direction in the imaging device 4. That is, the imaging device 4 constitutes the second positioning portion.

As described above, in the present embodiment, the first positioning portion and the second positioning portion are provided in different members. That is, the positioning of the optical member 6 in the plane orthogonal to the optical axis and the positioning of the optical member 6 in the optical axis direction are performed by different members, so that it is easy to improve the accuracy of each positioning.

A configuration of the second embodiment can be employed by being appropriately combined with various configurations (including a modified example) described in the first embodiment.

### Supplementary Notes of Invention

Hereinafter, an outline of the invention extracted from the above-described embodiment will be additionally described. Note that each configuration and each processing function described in supplementary notes below can be selected and optionally combined.

### Supplementary Note 1

A heating cooker including:

a heating compartment that has a panel member surrounding a compartment inner space capable of accommodating a heated object and configured to heat the heated object using an electromagnetic wave;

an imaging device that is disposed outside the heating compartment and configured to image an image of the compartment inner space through an opening portion formed in a part of the panel member; and

an optical member that is separate from the imaging device and is disposed on the compartment inner space side as viewed from the imaging device.

### Supplementary Note 2

The heating cooker according to Supplementary Note 1, in which the optical member includes a conversion lens.

### Supplementary Note 3

The heating cooker according to Supplementary Note 1 or 2, further including:

at least one of a first coupling structure configured to mechanically couple the optical member and the panel member, and

a second coupling structure configured to mechanically couple the optical member and the imaging device.

### Supplementary Note 4

The heating cooker according to Supplementary Note 1 or 2, further including:

a first positioning portion configured to define a position of the optical member in a plane orthogonal to an optical axis of the imaging device; and

a second positioning portion configured to define a position of the optical member in an optical axis direction of the imaging device.

### Supplementary Note 5

The heating cooker according to Supplementary Note 4, in which

the first positioning portion and the second positioning portion are provided in different members.

### Supplementary Note 6

The heating cooker according to any one of Supplementary Notes 1 to 5, further including

a support portion configured to support the optical member by coming into contact with one end face of the optical member in an optical axis direction of the imaging device at three or more support points.

### Supplementary Note 7

The heating cooker according to any one of Supplementary Notes 1 to 6, further including

a cooling structure configured to cool the optical member.

### SUPPLEMENTARY NOTE 8

The heating cooker according to any one of Supplementary Notes 1 to 7, further including

a shielding portion configured to surround a gap between the optical member and the imaging device and shield incident light to the gap.

What is claimed is:

1. A heating cooker comprising:
a heating compartment that has a panel member surrounding a compartment inner space capable of accommodating a heated object and configured to heat the heated object using an electromagnetic wave;
an imaging device that is disposed outside the heating compartment and configured to image an image of the compartment inner space through an opening portion formed in a part of the panel member; and
an optical member that is separate from the imaging device and is disposed on the compartment inner space side as viewed from the imaging device.

2. The heating cooker according to claim 1, wherein
the optical member includes a conversion lens.

3. The heating cooker according to claim 1, further comprising:
at least one of a first coupling structure configured to mechanically couple the optical member and the panel member, and
a second coupling structure configured to mechanically couple the optical member and the imaging device.

4. The heating cooker according to claim 1, further comprising:
a first positioning portion configured to define a position of the optical member in a plane orthogonal to an optical axis of the imaging device; and
a second positioning portion configured to define a position of the optical member in an optical axis direction of the imaging device.

5. The heating cooker according to claim 4, wherein
the first positioning portion and the second positioning portion are provided in different members.

6. The heating cooker according to claim 1, further comprising
a support portion configured to support the optical member by coming into contact with one end face of the optical member in an optical axis direction of the imaging device at three or more support points.

7. The heating cooker according to claim 1, further comprising
a cooling structure configured to cool the optical member.

8. The heating cooker according to claim 1, further comprising
a shielding portion configured to surround a gap between the optical member and the imaging device and shield incident light to the gap.
